(19) United States
(12) Patent Application Publication
(10) Pub. No.: US 2009/0091412 A1
(43) Pub. Date: Apr. 9, 2009

(54) Coil Integrated Inductor

(75) Inventors: Jae Young SHIN, Seongnam-si (KR); Kwang Young Kim, Giheung-gu (KR); Byung Moo Song, Seoul (KR); Yong Jin Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: ISU Corporation, Wonju-si (KR)

(21) Appl. No.: 11/867,179

(22) Filed: Oct. 4, 2007

(51) Int. Cl. H01F 27/02

(52) U.S. Cl. 336/83

(57) ABSTRACT

Disclosed is a coil integrated inductor. The coil integrated inductor includes a coil wound a predetermined number of times, electrodes joined to respective ends of the coil, and a magnetic body integrated with the coil and internal electrodes of the electrodes, in which the magnetic body includes magnetic powder, an organic binder and epoxy silane. When the magnetic body is formed, the mixed magnetic material including epoxy silane is used, so that the surface resistance and mechanical strength of the inductor according to the present invention can be remarkably increased.

### BACKGROUND OF THE INVENTION

1. Field of the invention

The present invention relates to a coil integrated inductor.

2. Description of the Prior Art

As generally known in the art, a conventional inductor includes an internally wound coil, electrodes respectively connected to both ends of the coil, and a composite magnetic body (hereinafter referred to as a magnetic body′) integrated with the coil and electrodes. The magnetic body is generally fabricated with the mixture of powered metallic magnetic material, such as sendust, iron or permalloy, and an uncured organic binder. The organic binder helps to increase the mechanical strength of a core itself, and to increase the resistance of the core by being between the metallic magnetic particles.

Since powdered sendust, iron and permalloy generally have high saturation magnetic flux density, they are not easily saturated by high current and provide an excellent current superposition characteristic. Such powder is molded together with the coil equipped with electrodes to be finally formed into a coil buried inductor, which is called a coil integrated inductor.

The inductor, in which the magnetic body surrounds the coil, can maximize the effective magnetic cross section, which in turn allows high inductance L, even in the case of a smaller number of coil turns. In particular, the fact that the number of coil turns is reduced means that the length of the coil is shortened in proportion to the reduced number, which allows reduced Direct Current Resistance (DCR) of the coil, and thus reduced heat generation, so that the efficiency of the inductor can be improved. The above described coil integrated inductor is widely used for power supply circuits of electronic devices which essentially require light, thin, short, small size as well as high efficiency. The coil integrated inductor is also called a Surface Mounted Device (SMD) since it is formed to have external electrodes capable of being surface-mounted to the power supply circuit.

However, in the above described coil integrated inductor, the buried electrode portions (internal electrodes) are in direct contact with the magnetic body, so that insufficient insulation between the electrodes and/or the core and the magnetic body is inevitable. A typical coil integrated inductor has a relatively low insulation resistance (or low surface resistance) ranging from several kiloohms (kΩ) to several megaohms (MΩ) between the electrodes and magnetic body thereof.

Furthermore, the binder used in the conventional coil integrated inductor has limited ability in increasing the mechanical strength. Besides, as indicated by reference character A in FIG. 1, portions of electrodes of the inductor are disposed on and coupled to specific surfaces of the magnetic body, so that they are structurally unbalanced, with the result of a problem occurring in that the mechanical strength thereof is very low at those portions.

### SUMMARY OF THE INVENTION

The present invention is based on the finding that adding epoxy silane to a magnetic composition for preparation of a magnetic body of an inductor can increase not only the surface resistance of the magnetic body, but also the coupling strength between an organic binder and an inorganic metallic magnetic material, resulting in higher mechanical strength of the magnetic body.

Accordingly, the present invention has been made to solve the above-mentioned problems occurring in the prior art, and the present invention provides a coil integrated inductor which has higher surface resistance and improved mechanical strength.

In accordance with an aspect of the present invention, there is provided a coil integrated inductor which includes a coil wound a predetermined number of times, electrodes joined to respective ends of the coil, and a magnetic body integrated with the coil and internal electrodes of the electrodes, in which the magnetic body includes magnetic powder, an organic binder and epoxy silane. The magnetic body may further include insulation filling material, lubrication material, or both of the insulation filling material and lubrication material.

In accordance with another aspect of the present invention, there is provided a magnetic composition for preparation of a magnetic substance which includes metallic magnetic powder, an organic binder, and epoxy silane.

### BRIEF DESCRIPTION OF THE DRAWINGS

The above and other objects, features and advantages of the present invention will be more apparent from the following detailed description taken in conjunction with the accompanying drawings, in which:

FIG. 1 is a view of an example of a conventional coil integrated inductor;

FIG. 2 is a perspective view of a coil integrated inductor according to an embodiment of the present invention;

FIGS. 3 and 4 are views illustrating a coil and electrodes of the coil integrated inductor according to an embodiment of the present invention;

FIG. 5 is an enlarged view illustrating the coil and electrodes of the coil integrated inductor according to an embodiment of the present invention;

FIG. 6 is a top plan view illustrating the coil, electrodes, and a magnetic body according to an embodiment of the present invention;

FIG. 7 is a top plan view of the coil integrated inductor according to an embodiment of the present invention, which shows a top surface of the magnetic body having a resting portion formed on;

FIG. 8 is a bottom plan view of the coil integrated inductor according to an embodiment of the present invention, which shows a bottom surface of the magnetic body;

FIG. 9 is a perspective view of the coil integrated inductor according to an embodiment of the present invention, in which external electrodes have been cut;

FIG. 10 is a perspective view of the coil integrated inductor according to an embodiment of the present invention, in which the external electrodes have been bent;

FIG. 11 is a partially enlarged view illustrating the magnetic body of the coil integrated inductor according to an embodiment of the present invention; and

FIG. 12 is a flowchart illustrating a process of manufacturing a coil integrated inductor according to an embodiment of the present invention.

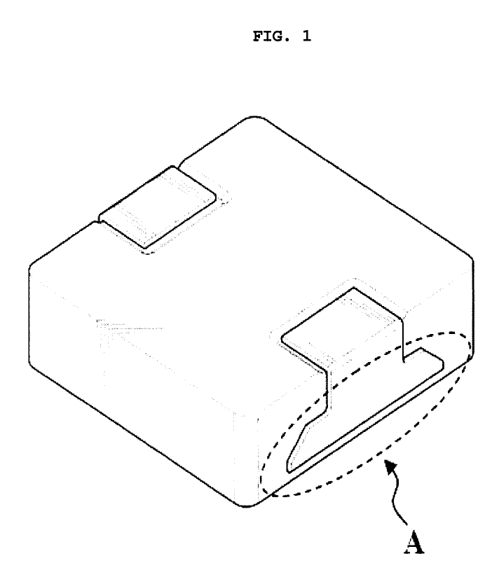

### DETAILED DESCRIPTION OF THE EXEMPLARY EMBODIMENTS

Hereinafter, an embodiment of the present invention will be described with reference to the accompanying drawings. In the following description and drawings, the same reference numerals are used to designate the same or similar components, and so repetition of the description on the same or similar components will be omitted.

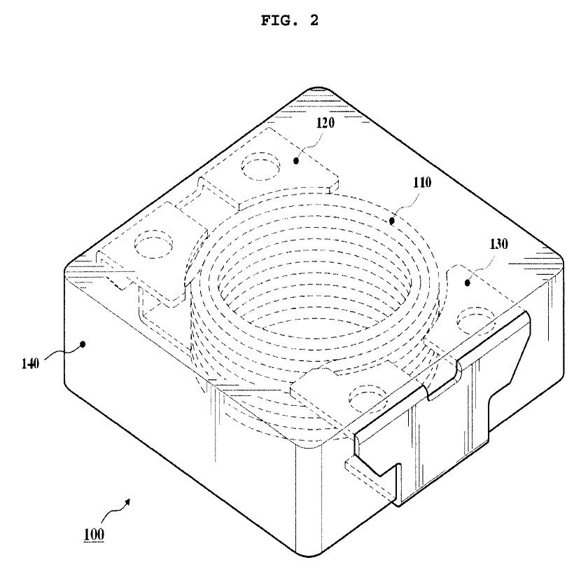

FIG. 2 is a perspective view of a coil integrated inductor according to an embodiment of the present invention. Referring to the drawing, the coil integrated inductor 100 (hereinafter ‘inductor’) includes a coil 110 wound a predetermined number of times, conductive electrodes 120 and 130 connected to respective ends of the coil, and a magnetic body 140 integrated with the coil 110 and a portion of the electrodes 120 and 130.

The present invention is characterized in that epoxy silane is added to the magnetic body to increase the surface resistance, as well as the mechanical strength (refer to Table 1).

The magnetic body 140 of the present invention may be formed by, for example, a compression molding of a magnetic composition for preparation of the magnetic body containing magnetic powder, an organic binder, and epoxy silane with a mold.

The epoxy silane serves as a coupling agent acting on the surfaces of an organic polymer and an inorganic material. Namely, epoxy silane can increase the coupling strength between the inorganic, metallic magnetic material and the organic binder, thereby enhancing the mechanical strength of the magnetic body 140.

It is considered that an epoxy group in epoxy silane is covalently bonded and/or hydrogen-bonded to the organic binder via a ring-opening reaction when the magnetic body is prepared from the magnetic composition containing magnetic powder, an organic binder, and epoxy silane.

In addition, a phosphoric acid treatment may be carried out on the magnetic powder to form a phosphoric acid (H₃PO₄) film which is strongly coupled to the binder by the silane in the epoxy silane, increasing the surface resistance.

The magnetic powder may include, for example, but is not restricted to, iron powder, permalloy powder, sendust powder, amorphous alloy powder, ferrite powder, etc., which may be used either alone or in mixtures thereof. The particles of the magnetic powder have preferably a spherical shape, the mean particle diameter of which is preferably from 3 to 30 μm, more preferably from 3 to 10 μm The reason for this is because the probability of damaging the insulation film of the coil 110 in a process of forming the magnetic body 140 is high in the case where the particles have a large size or have non-spherical-shaped sharp corners.

Since the magnetic powder contains metallic powder, it must be insulated in an appropriate manner, in contrast to a ceramic magnetic substance having a high resistance by itself. If the magnetic powder is not insulated above a predetermined level, inter-particle eddy current loss increases and thereby high heat is generated. An example of the method for insulating the magnetic power is an acid treatment on the surfaces of the magnetic powder particles using phosphoric acid, for example. For example, Silica (SiO₂) may be coated, in a proportion of 0.1%, on the surfaces of the metallic powder particles for a first insulation, phosphoric acid (H₃PO₄) may be then coated on the silica coated surfaces to form films of FePO₄ for a second insulation, and a third insulation can be achieved by the binder and the silane protecting the films of FePO₄.

Polyimide resin or epoxy resin is suitable for the organic binder. In addition, the organic binder may include a synthetic resin, an acrylic-based resin, or a synthetic rubber-based resin, for example. The binder may be provided in liquid form by using an organic solvent, such as alcohol, metha ethyl ketone, etc., to enhance its miscibility with the magnetic power.

The content of the binder is preferably in the range of 1 to 6 weight percent, based on the weight of the magnetic powder. The higher the content of the binder added is, the greater insulation characteristic between the particles of the magnetic powder, but the lower magnetic permeability and saturation magnetic flux density is accompanied with that.

An example of epoxy silane may be γ-Glycidoxypropyltrimethoxysilane (C₉H₂O₅Si) which can be represented as the following chemical formula:

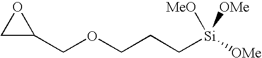

According to a characteristic aspect of the present invention, epoxy silane is preferably added in the range of 0.5 to 3 weight percent based on 100 weight percent of the magnetic powder when the content of the binder is in the range of 1 to 6 weight percent based on 100 weight percent of the magnetic powder.

The magnetic composition for preparation of the magnetic body, which contains the metallic magnetic powder, the organic binder, and epoxy silane, is preferably prepared in the form of granule.

An example of the preparation of the magnetic composition in the form of granule is described below. First, the liquid organic binder together with epoxy silane are thoroughly mixed in the magnetic powder, and the organic solvent is then volatilized from the mixture in an oven heated to a temperature of about 100° C. Thereafter, the mixture of the binder, epoxy silane, and magnetic powder comes into a cake-state. The cake is passed through a 200-mesh sieve to produce granules of the magnetic composition.

Another method for preparing the granules may include spray drying. This method includes, for example, forming the liquid binder, epoxy silane, and magnetic powder into a slurry having a viscosity of about 1000 cps. The slurry is then sprayed in a dryer heated in the temperature range from 70 to 100° C. to produce spherical granules of about 100 μm.

Meanwhile, the magnetic composition for preparation of the magnetic body may be mixed with additional material, such as insulation filling material and lubrication material before being loaded into a mold.

The insulation filling material can further increase the insulation characteristic of the magnetic composition for preparation of the magnetic body in the form of granule, and may include Talc, Kaolin, MgO, CaO or a mixture thereof. The content of the insulation filling material is preferably 0.5 to 5 weight percent based on the 100 weight percent of the magnetic powder. Although the present invention is not limited to this weight percent range of the insulation filling material, sufficient insulation of the magnetic powder cannot be expected in the case where the content of the insulation filling material is relatively small, and the saturation magnetic flux density decreases in the case where the content thereof is relatively large.

The lubrication material functions to improve the fluidity of the mixed magnetic composition and/or the insulation filling material in the mold. Material selected from the group consisting of, but not restricted to, zinc stearate, calcium stearate and various types of waxes, or a mixture thereof, may be used as the lubrication material. It is preferred that the added amount thereof be 0.1 to 0.7 weight percent based on 100 weight percent of the magnetic powder.

Hereinafter, explained will be the coil, electrodes, and magnetic body of the coil integrated inductor according to an embodiment of the present invention in detail.

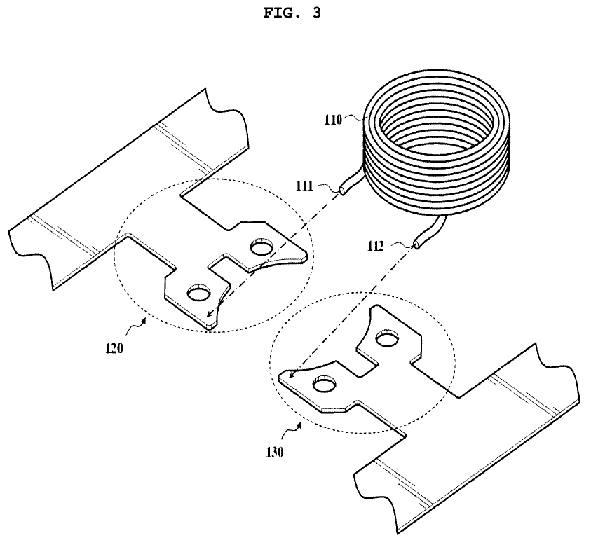

The first and second ends 111 and 112 of the coil 110, as shown in FIG. 3, are respectively joined to the first electrode 120 and the second electrode 130 through welding or soldering. The coil may be made of appropriate metal, such as Cu, Ag or Au, or alloy thereof. The coil 110 is configured such that the surface thereof is coated with a resin-based insulating film. In the case where the predicted heating temperature of a circuit is above 125° C., it is preferred that the insulating film be made of polyamide-based material, but the present invention is not limited thereto.

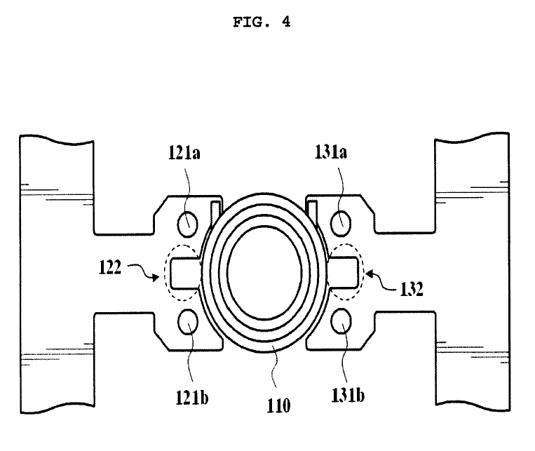

The electrodes 120 and 130, as shown in FIG. 4, are provided with a pair of coupling holes 121a and 121b and a pair of coupling holes 131a and 131b, respectively. These coupling holes function to increase the coupling force between the electrodes 120 and 130 and the magnetic body 140.

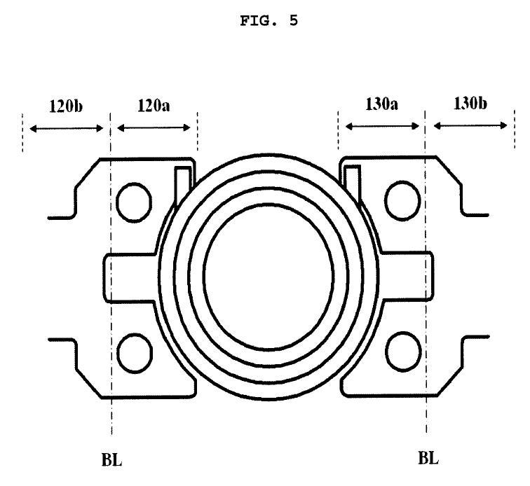

Furthermore, curved portions corresponding to the curvature of the coil 110 are formed at respective edges of the electrodes 120 and 130 opposite the coil 110. In addition, depressions 122 and 132 may be formed at a predetermined depth at the respective center of the curved portions to increase the coupling force between the magnetic body 140 and the electrodes 120 and 130. The depressions 122 and 132 may have a depth corresponding to bending lines BL shown in FIG. 5. In this case, the bending lines BL refer to virtual lines at which the electrodes 120 and 130 are bent. The magnetic body 140 is located between the two bending lines BL. Although in the present embodiment, the diameter of each of the coupling holes is set to fall within the range of 0.3 to 1 mm, the present invention is not limited thereto because the diameter may vary according to the size of the inductor and the size of the electrodes 120 and 130.

In greater detail, the portions of the electrodes 120 and 130 integrated with the magnetic body 110 on the basis of the bending lines BL are defined as internal electrodes 120a and 130a, and the remaining portions of the electrode 120 and 130 are defined as external electrodes 120b and 130b.

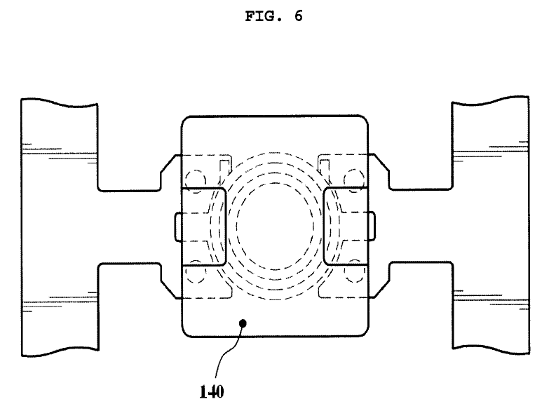

FIG. 6 shows the magnetic body 140 including the coil 110 between the bending lines BL.

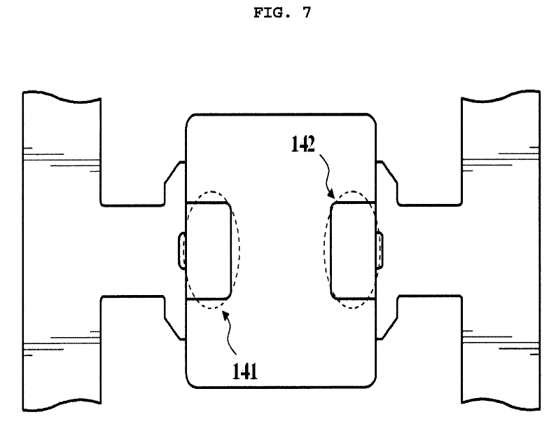

The resting portions 141 and 142 (refer to FIG. 7), which are configured such that the external electrodes 120b and 130b are bent along the bending lines BL and are rested on the top surface of the magnetic body 140, which is made of the magnetic composition and the additional material using the mold, are provided. The above-described resting portions are formed using protrusions provided in the mold (not shown).

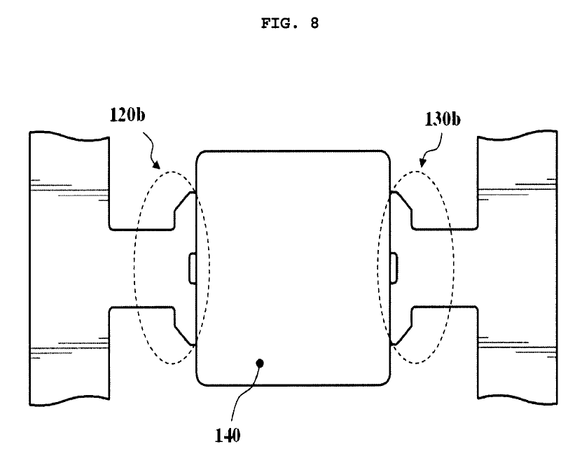

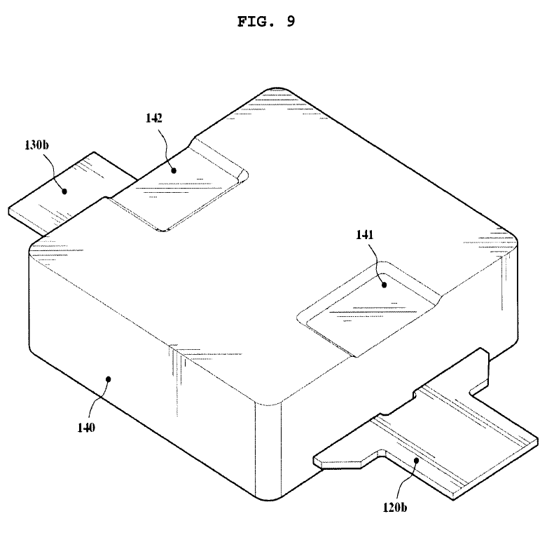

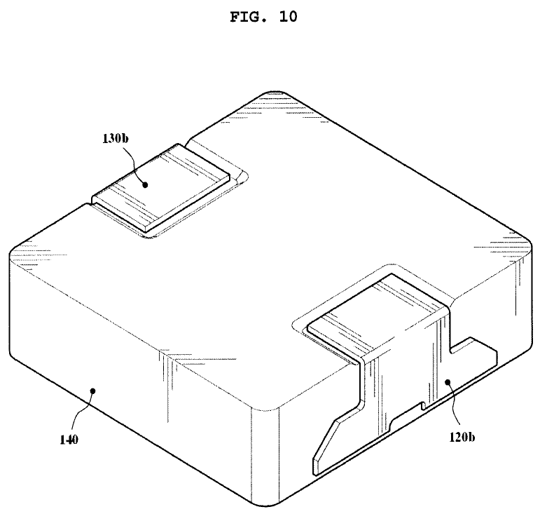

FIG. 8 shows the bottom surface of the magnetic body 140, FIG. 9 shows the state in which the external electrodes 120b and 130b have been cut, and FIG. 10 shows the state in which the cut external electrodes 120b and 130b have been bent and have been rested on the resting portions.

The inductor 100 according to the present invention may have a current superposition characteristic that varies according to the internal diameter of the coil 110. When the internal diameter of the coil is basically set such that the internal sectional area of the coil of a formed inductor is the same as the external sectional area thereof, the inductor 100 exhibits the best current superposition characteristic. In the present invention, it is preferred that the internal sectional area of the coil fall within the range of 70 to 130% based on the external sectional area thereof. Although the inductance value thereof increases at the same number of coil turns in the case where the internal sectional area of the coil is greater than the external sectional area thereof, the exterior of the coil is magnetically saturated faster than the interior thereof, so that the current superposition characteristic decreases, increasing the generation of heat. In the opposite case, the effective magnetic sectional area of the interior of the coil decreases and thus the inductance value thereof decreases, so that the interior of the coil is magnetically saturated faster than the exterior thereof, decreasing the efficiency thereof.

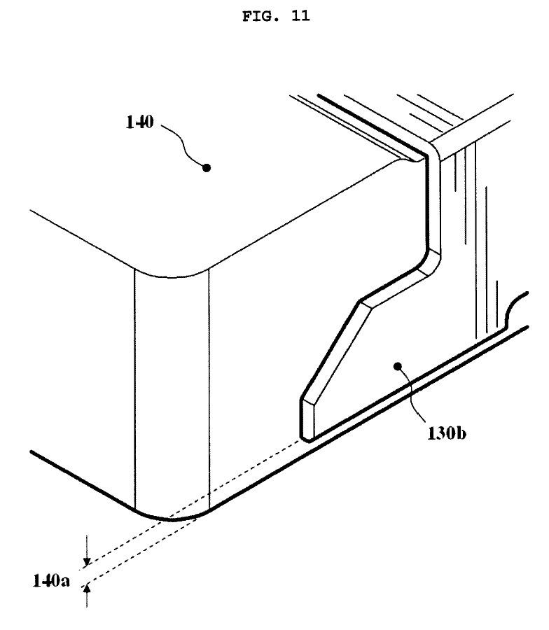

Furthermore, as shown in FIG. 11, the height of the lower end portion of the magnetic body 140, that is, the height of a lower magnetic body 140a located below the internal electrodes 120a and 130a and the coil 110, may be preferably set such that the effective magnetic sectional area formed by the lower magnetic body 140a is about 60% of the sectional area of the interior of the coil 110. When the height of the lower magnetic body 140a is set such that the effective magnetic sectional area is less than 60%, the magnetic saturation of the lower magnetic body 140a first arises, so that the current superposition characteristic decreases, increasing the generation of heat. In contrast, when the height of the lower magnetic body 140a is set to be too great, the effective magnetic sectional area increases unnecessarily, so that the size of the inductor increases, obstructing the implementation of the small-sized inductor.

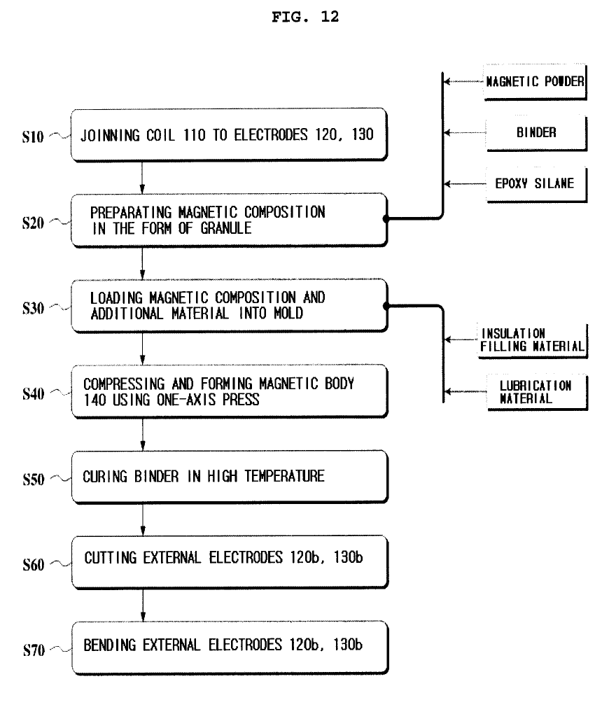

The method of manufacturing the coil integrated inductor 100 according to an embodiment of the present invention will be described with reference to FIG. 12 below. First, the ends 111 and 112 of the coil 110 wound a predetermined number of coil turns are joined to the electrodes 120 and 130, respectively, at step S10.

Granular magnetic composition is provided by mixing magnetic material, binder and epoxy silane at step S20.

Thereafter, the coil 110 joined to the electrodes 120 and 130 is disposed in a mold (not shown), and the magnetic composition and the additional material are mixed and then are loaded into the mold at step S30.

After step S30, the magnetic composition and the additional material are compressed by a force of 3 to 10 ton/cm³ using a one-axis press (not shown), and thereby the magnetic body 140 is formed at step S40. In this case, it is preferred that the density of the magnetic body 140 be 5.0 to 7.2 g/cm³ after the compression and forming.

After steps S10 to S40, the inductor 100 ejected from the mold undergoes heat treatment for 1 or 3 hours at a high temperature in the range of 120 to 140° C. in which the binder is cured, at step S50.

Finally, the external electrodes 120b and 130b are cut to have a length such that they can be rested on the respective resting portions 141 and 142 formed on the top surface of the magnetic body 140, and are bent, at steps S60 and S70.

Hereinafter, a preferred embodiment of the present invention will be explained. The preferred embodiment is only for illustration purposes and is not intended to be limited thereto.

### EXAMPLES

In this preferred embodiment, the magnetic compositions for preparation of the magnetic bodies included Carbonyl Iron Powder as the magnetic powder, binder (product name: ‘Vinylresol resin’) described in Table 1 and epoxy silane (C₉H₂O₅Si), each having the content shown in Table 2 (weight percent based on the weight of the magnetic powder) below, and Zinc as lubrication material having the amount of 0.2 weight percent, was used.

Coil integrated inductors having the dimensions of 10 mm×10 mm×3 mm were prepared according to the process shown in FIG. 12. Table 2 shows the surface resistances and mechanical strength of the manufactured inductors.

The surface resistance was obtained through the measurement of resistance between the external electrodes and the top surface of the magnetic body. The mechanical strength was obtained through the measurement of the bending strength value thereof after a bar-shaped workpiece having dimensions of 20 mm×10 mm×5 mm had been manufactured.

TABLE 1
Component name and content of binder

| Chemical material name | Content (wt %) |
|---|---|
| Phenol resin | 42~45 |
| Phenol | 0.3~1.2 |
| Water | 16~17 |
| Formalin | 0.2 |
| Vinylbutyral polymer | 6 |
| methyl alcohol | 25 |
| etc. | 9 |

TABLE 2

| | | Surface | |
|---|---|---|---|
| | | resistance | Strength |
| Comparative | Binder 4 wt % | 60 MΩ | 450 N |
| Example 1 | | | |
| Example 1 | Binder 4 wt % + Epoxy | 450 MΩ | 600 N |
| | Silane | | |
| | 0.5 wt % | | |
| Example 2 | Binder 3.5 wt % + Epoxy | 500 MΩ | 550 N |
| | Silane | | |
| | 1 wt % | | |
| Example 3 | Binder 3 wt % + Epoxy | 400 MΩ | 360 N |
| | Silane | | |
| | 1.5 wt % | | |

From the comparison of results of Comparative Example 1 and example 1, it can be seen that when epoxy silane was added, the surface resistance was remarkably increased from 60 MΩ to 450 MΩ, and the mechanical strength from 450N to 600N.

When the magnetic body 140 is formed, the mixed magnetic material including epoxy silane is used, so that the surface resistance and mechanical strength of the inductor according to the present invention can be remarkably increased.

In addition, the coupling force between the magnetic body 140 and the electrodes 120 and 130 can be increased by the coupling holes and the depressions, which are formed in the internal electrodes 120a and 130a. This reduces the damage to the lower magnetic body, which conventionally occurs when bending the external electrodes, so that the reliability of the inductor can be increased.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A coil integrated inductor, comprising:
a coil wound a predetermined number of times;
electrodes joined to respective ends of the coil; and
a magnetic body integrated with the coil and internal electrodes of the electrodes;
wherein the magnetic body includes magnetic powder, an organic binder and epoxy silane.

2. The coil integrated inductor as claimed in claim 1, wherein the magnetic body further comprises insulating filling material, lubrication material, or both of the insulating filling material and the lubrication material.

3. The coil integrated inductor as claimed in claim 1, wherein the magnetic body is formed by using a mold.

4. The coil integrated inductor as claimed in claim 1, wherein the magnetic powder is one or more selected from the group consisting of iron powder, permalloy powder, sendust powder, amorphous alloy powder, and ferrite powder.

5. The coil integrated inductor as claimed in claim 1, wherein the organic binder and the epoxy silane account for 1 to 6 weight percent based on 100 weight percent of the magnetic powder and 0.5 to 3 weight percent based on 100 weight percent of the magnetic powder, respectively.

6. The coil integrated inductor as claimed in claim 2, wherein the insulating filling material and the lubrication material account for 0.5 to 5 weight percent based on 100 weight percent of the magnetic powder and 0.1 to 0.7 weight percent based on 100 weight percent of the magnetic powder, respectively.

7. The coil integrated inductor as claimed in claim 1, wherein each of the internal electrodes of the electrodes has a pair of coupling holes.

8. The coil integrated inductor as claimed in claim 1, wherein each of the internal electrodes of the electrodes is formed to have a curved portion at an edge thereof opposite to the coil, the curved portion having a depression at a center thereof

9. A magnetic composition comprising:
a metallic magnetic powder which is insulation-treated using phosphoric acid to form an insulating film on the surface of particles of the magnetic powder;
an organic binder; and
an epoxy silane,
wherein the composition is suitable for preparation of a magnetic substance.

10-11. (canceled)

12. The magnetic composition as claimed in claim 9, wherein the organic binder is a polyimide resin, epoxy resin, synthetic resin, acrylic resin, synthetic rubber resin, or a mixture thereof.
